(19) United States
(12) Patent Application Publication
(10) Pub. No.: US 2024/0394812 A1
(43) Pub. Date: Nov. 28, 2024

(54) ONLINE APPLICATION AND METHOD OF TRANSACTION FOR BUYERS, SELLERS, RENTERS AND 3RD PARTY REAL ESTATE PROVIDERS

(71) Applicant: Sriram Varadhan, Frisco, TX (US)

(72) Inventor: Sriram Varadhan, Frisco, TX (US)

(21) Appl. No.: 18/201,131

(22) Filed: May 23, 2023

(51) Int. Cl. G06Q 50/16

(52) U.S. Cl. CPC G06Q 50/16

(57) ABSTRACT

An online application and method to provide an online marketplace to enable real estate sellers, buyers and other service providers associated with the real estate industry to transact on real estate transaction while eliminating the idea of commissions involved in real estate buying and selling process. The present invention allows for direct communication between buyers, sellers, service providers and all other parties involved in a real estate transaction via a single platform.

The real estate market is characterized by numerous inefficiencies that create problems for sellers, buyers, businesses, and third parties related to relate estate transactions. It can often be quite complicated due to the complexity of the property rights being transferred, the amount of money being exchanged, the commissions charged, and the time and resources involved.

Selling and buying real property is generally a time-consuming process requiring the assistance of several professional services at a considerable cost. The typical seller is unfamiliar with the marketing required to sell their property and cannot access marketing channels used by real estate agents, such as the Multiple-Listing Service (MLS). Also, the typical seller does not have sufficient familiarity with comparable sales in their area to assess the market price for their property. If a potential buyer is located, the typical seller does not have the legal resources necessary to negotiate a purchase contract and to close the transfer. Consequently, sellers often use seller agents to list and show the property for significant commissions, as much as 6% or 7% of the sale price, even when the agents perform a very small service. In addition, sellers typically do not have the ability to sell by owner on an equal footing, and thus may have no real alternative other than paying the large commission. Although many real estate online platform and system provide visibility into property listing information on their web sites and platform, there is still the issue of high commissions as a result of the intensifying competition among agents. Real estate is not only popular as an investment but also a network system that brings not only buyers and sellers together but other third parties involved in a real estate transaction such as lawyers, mortgagors, and escrow officers, providing the opportunity to be connected and the extent to which they are involved in the day-to-day operation of real estate transaction. Real estate transactions are typically accomplished through a chain of communication systems that are largely not integrated and often not even electronical. Each party (e.g., buyer, buyer's agent, seller, seller's agent, title provider, mortgage provider, real estate attorney, inspectors) generally keep their own personal schedules. The parties have to contact one another to establish appointments. This may be exceedingly difficult if more than two of the parties have to find mutually convenient times. Also, having to contact parties by telephone is often inadequate due to unavailability. There is a problem when a seller a seller or buyer is not readily provided with information and easy means to secure professional service and network with credible source needed in the real estate transaction.

At present there is no prior arts, application or platform that is built around the idea of eliminating the commissions involved in real estate buying and selling process by providing a direct chat system between the buyers, sellers, lenders, registrars and all other 3rd party real estate businesses to make negotiations easier, and reliable. There is a need for a system that overcomes limitations of the current real estate system, as well as providing additional benefits.

The present invention strives to provide an online application and method for real estate transactions, and strives to make the real estate market more accessible through digitalized means while reducing the costs and time wasted in selling and purchasing or renting properties while eliminating unwanted commissions. The most unique part about the present invention is that it unifies vendors, buyers and real estate service providers which include mortgage lenders, appraisers, inspectors, title companies, escrow companies, insurers, contractors, moving companies, and other providers whose services relate to property transactions into one platform making negotiations easier. It helps not only the buyers, renters and sellers but also the businesses in this industry.

### FIELD OF INVENTION

This disclosure relates generally to online real estate transaction application and platform, more particularly, relates to a one-stop-smart hub online application and platform for real-estate transactions.

### DESCRIPTION OF RELATED ARTS

U.S. Pat. No. 9,105,061B2 to discloses Under an embodiment of the invention, a web site system that maintains a real estate web page. The web page has an aerial image map of a geographic region that can be navigated by a user. The web site system facilitates online collaboration for real estate transactions. When the user registers, the system creates a user account for real estate information. Real estate agents and/or other real estate service providers selected by the user are granted shared access to the user's account by the web site system.

Another such application by U.S. Pat. No. 11,636,522 to Jackson Beatty, which discloses a method to provide feedback associated with a real estate listing including providing access to a real estate listing via a system including at least a listing recommendation server that communicates with a real estate feedback application. Then receiving feedback regarding the real estate listing from a handheld device operating the real estate feedback application. Then sharing the feedback with a showing agent associated with the real estate listing.

U.S. Pat. No. 11,610,241B2 discloses a network based real estate transaction system is disclosed for assisting real estate agents and their clients with determining properties for purchase.

U.S. Patent application No. US20060190278A1 disclose an apparatus, method and program product to provide an online marketplace to enable real estate sellers, passive, real estate investors, and master lessees and sponsors of TIC transactions to contract regarding fractional and other real estate interests, including TIC property, remainder interest, estate for years, subordinated fee interest and sale-leaseback scenarios. Property investment, financing, management, TIC-owned and TIC sponsor profiles are automatically matched to queries to determine potential contracting entities. Transactions initially focus on real estate-secured income streams, rather than property addresses and specifics, to allow sellers and buyers and master lessees to contract without initial regard to actual property location or ability to independently circle funds.

U.S. Pat. No. 7,451,150B2 discloses a system and process includes a computer that is operatively connected to an area network, such as to the Internet. A database of MLS properties that are for sale is maintained that is accessible to the computer. Real estate agents must subscribe in order to use the system and are then included in the database. Clients may be either prospective buyers or sellers of the MLS properties. Each client is required to complete a client commitment form whereby the client elects to have a currently subscribing real estate agent represent them before they are allowed access to the information and services provided. Current client files are also included in the database. Real estate agents are given the full functionality that is offered to the clients in that they may view any of the client's files and activities and they are also allowed to post upcoming MLS properties that are to be offered for sale and to FAX property defects that are made available only to other real estate agents. Agents are also able to view the activity of any of their own listings.

U.S. Patent application No. 20100057524 discloses a present invention that provides methods and systems for providing real-estate information using a computer network, such as the Internet. A buyer information web page showing relevant buyer list information in an easy-to-read, summary format is created and displayed to a real estate agent. Buyer information provided includes summaries of various aspects of information needed by a real estate agent to effectively represent and assist a buyer. Examples of information provided include a potential buyer name, a new activity summary summarizing newly-listed properties and other activity meeting the buyer's profile, a new views summary summarizing any views of detailed property information by the buyer using an online property data search and information system provided by the agent, and a new tags summary summarizing any properties that the buyer or the agent finds of particular interest. Moreover, a comparative market analysis (CMA) list web page showing relevant CMA information in an easy-to-read, summary format is also created and displayed to the real estate agent.

U.S. Pat. No. 9,213,461B2 discloses an innovative web-based tool displays visual information about real estate. In one embodiment, an aerial image is overlaid with various data layers to visually present real estate data. Data associated with various embodiments of the tool can include tax parcel information, historical sales information, Multiple Listing Service information, school information, neighborhood information, and park information.

U.S. Pat. No. 11,532,057 to Shourabh Rawat discloses a system for updating a database comprises an input interface and a processor. The input interface is configured to receive image data. The processor is configured to determine from the image data one or more attributes of a database entry for real estate property and update the database entry for the real estate property.

There are many prior art websites and online application and methods that allows individual listing by themselves, but it doesn't fulfill the needs to furnish the property or directly chat with an attorney or an insurance provider if there's any issue with the real estate deal.

### SUMMARY OF THE INVENTION

The following summary is provided to facilitate an understanding of some of the innovative features unique to the present invention, this is not intended to be a full description. A full description of the various aspects of the invention can be gained by taking the entire specification, claims, and abstract as a whole.

The invention provides an online one-stop-smart hub application and methods for assisting the buying and selling of properties. The invention serves as a point of contact for sellers, buyers, negotiators and third-party service providers in the real estate market within a particular geographical location, offering a forum for identifying needs, presenting solutions and accessing a suite of real estate tools and services. The present invention provides help to sellers without the help of any paid support. They can list their property for free in just 3 easy steps.

The present invention is also built around the idea of eliminating the commissions involved in real estate buying and selling process. The application algorithm of the present invention includes a location-based pull mechanism of all users, and includes a direct chat system between the buyers, sellers, lenders, registrars and all other 3rd party real estate businesses. All details about the property and its specifics can be negotiated online via the application system. Once the prospective buyers and sellers show interest in the listed properties, the present invention helps them connect with the third parties required to ease the transaction by scheduling appointments for required services directly on the platform. The application and system offer listings of service providers such as attorneys, notaries, mortgage lenders and escrow officers/registrars all through the application. The buyers and sellers in the real estate market can save time and get the deal done with minimal effort.

In an embodiment, a method of the invention includes providing an online application interface that sellers can use to provide information regarding properties they wish to sell, that can be used to publish the property-for-sale information to many buyers, and that buyers can use to provide information regarding properties they wish to buy. That is, sellers can use the online application interface to post properties for sale knowing that the information will be accessed by buyers who are ready to purchase a property within a geographical location. Similarly, buyers can use the online interface to search for a desired property. The method further includes a user interface wherein property buyer or seller in the area can easily locate the business through their business card using the application of the current invention connection feature. Similarly, the application of the current inventions provides different feeds for each type of service required in the real estate market. A user can apply the filters for the local area, and buyers/sellers are likely to come across users' business's profile as well. Through direct chatting systems on the application platform of the current invention, all deals and negotiations can be made online without the need for regular in-person meetings. Consequently, parties save significant sums on traveling costs and other related requirements.

### BRIEF DESCRIPTIONS OF DRAWINGS

FIG. 1a through FIG. 1c discloses the Profile creation display screen of the user interface Mobile application of the present invention;

FIG. 2 discloses the display screen option selection for other users of the Mobile application of the present invention;

FIG. 3 display screen of the surrounding 3rd party business users in the ‘Others’ tab when a buyer logs in the application. It also gives option to the buyer as a step-by-step wizard through unique feature, ‘Fifsee connection’ to locate lenders of the application of the present invention

FIG. 4 discloses the display screen of the Buyers feed when Lenders/mortgage business user logs in through mobile application of the present invention. The lenders also get to choose ‘More options’ and get to see Tenant feed and Owner of Landlords feed of the application of the present invention.

FIG. 5 is a feed screens of the Lender/Mortgage or banker logs display of the mobile application after they choose the ‘More options’ from the previous FIG. 4 of the present invention;

FIG. 6 is a feed screens of the Buyers, Sellers, Landlord/tenants display when any other businesses from FIG. 2 logs into the mobile application of the present invention.

FIG. 7 is a feed screens of the buyer's login display to submit bids for sellers of the mobile application of the present invention;

FIG. 8 is a feed screens of the seller's login display indicating the acceptance of buyers bid of the mobile application of the present invention;

FIG. 9 is a flow chart of the step-by-step process of the present invention method.

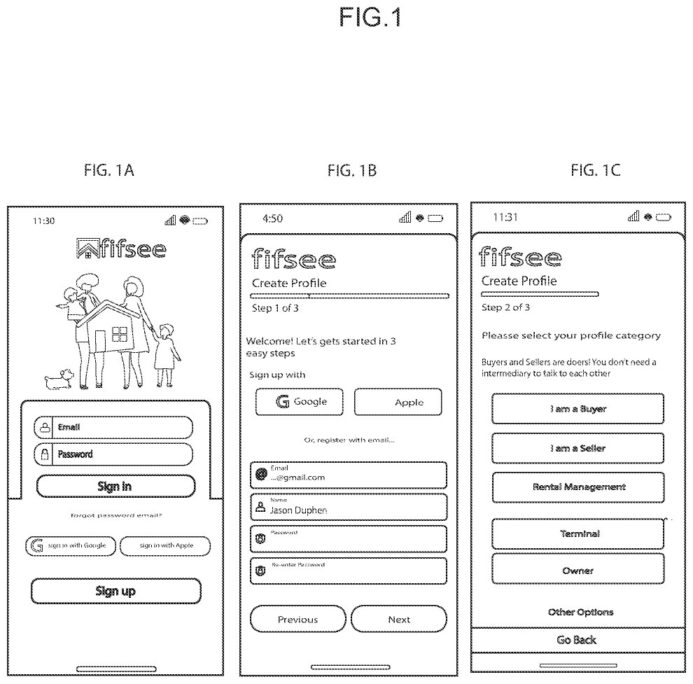

In FIG. 1a through FIG. 1c, of the present invention discloses the Profile creation display screen of the user interface Mobile application. The interface allows the application to collect user's email id, name and password. FIG. 1b display screen provides user with a profile option, allowing a user to either select the I'm a buyer option, I'm a Seller option, I'm a renter (A. Tenant B. Landlord) and other option such as lenders/mortgage banks, attorney services and Notary services. When a user selects ‘I'm a Buyer’ during profile creation, the present invention algorithm collects buyer's personal information such as email id, location choices from the User interface with the miles range of choices, Collect buyer's budget price from the user interface, and further stores in a database. Upon saving the user profile, the interface locates sellers matching the above information and populate all the matching sellers in buyer's feed on the application user interface whenever the buyer logs in. furthermore, the Buyer is able to directly chat with all or any of the sellers listed on the feed (TAB: Sellers) and perform all other functions such as Bid, like, bookmark, dispute, etc. Similarly, the buyer is able to see another tab on feed (TAB: Others) as shown in FIG. 1c and see all businesses listed above such as Lenders, Plumbers, Appraisers, etc. buyer can chat, schedule appointments, and write reviews about their businesses.

Upon selecting ‘I'm a Seller’ during profile creation, the present invention algorithm collects sellers' property details such as pictures, description, property address, price (fixed or bidding).

If bidding; the algorithm collects the dates offered with the initial price, bedrooms, lot size, living area, web URL etc. And further Store in database. Upon saving the user profile, the interface locates the buyers matching the above information and address, and populate all the matching buyers in the locality per buyer's choices listed above, display on buyer's feed on the application user interface whenever the sellers log in. furthermore, Sellers are able to directly chat with all or any of the buyers listed on the feed (TAB: Buyers) and perform all other functions such as respond to buyer's Bid, like, bookmark, dispute, etc. Similarly, the sellers are able to see another tab on feed (TAB: Others) as seen in FIG. 1c and see all businesses listed above such as Lenders, Plumbers, Appraisers, etc. and perform chat, schedule appointments, and write reviews about their businesses.

Upon selecting ‘Others’ during profile creation the present invention algorithm collects business details such as pictures, License or registration number, full addresses and further Store in its database. It further locates the buyers, sellers, tenants and landlords matching the above information and populate all the clients in other's feed on the application user interface whenever ‘Others’ logs in using their email id. The ‘Others’ are able to directly chat with all or any of the buyers, sellers, tenants and landlords listed on the feed (TAB: Buyers, Sellers, Tenants, Landlords) and perform appointments scheduling, like, dispute, etc.

When user selects ‘I'm a Tenant’ during profile creation, the algorithm collects tenant's location choices from the user interface along with the miles range of choices, tenant's rental budget price from the user interface, and further Store it in the database. Upon saving the user profile the algorithm locates the landlords matching the above information and populate all the landlords in tenant's feed on the App user interface. When the tenant logs in such as, rental duration offered, price, property details etc. Tenants are able to directly chat with all the renters listed on the feed and perform all other functions such as like, bookmark, contact, etc.

Upon selecting ‘I'm a landlord’during profile creation, the present invention algorithm collects landlord's property details such as pictures, description, property address, rent amount, property type, bedrooms, lot size, living area, web URL etc. And further Stored in database. Upon saving the user profile, the interface locates the tenants and surrounding businesses (others) matching the above information and address, and populate all the matching tenants in the locality per tenant's choices listed above, display on tenant's feed on the application user interface whenever the sellers log in. landlords are able directly o chat with all the tenants listed on the feed (TAB: Tenants) and perform all other functions such as, like, bookmark, dispute, etc. Similarly, the landlords are able to see another tab on feed (TAB: Others) and see all businesses listed above such as Lenders, Plumbers, Appraisers, etc. and perform chat, schedule appointments, and write reviews about their businesses.

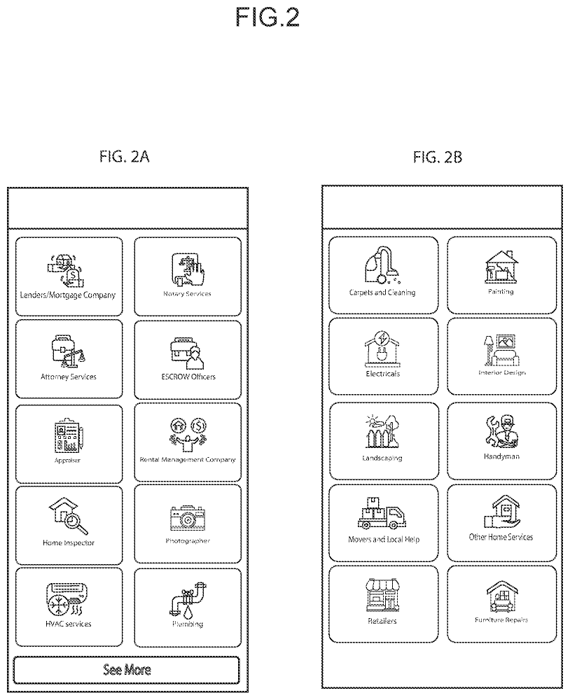

In FIGS. 2a & 2b, the invention displays the option selection screen for other users of the Mobile application of the present invention such as Lenders, escrow officers, Plumbers, Appraisers, Attorneys, Home Inspectors, Photographers, Retailers, Handyman, Painters, Electricals, HVAC and Other Home services related to real estate transactions.

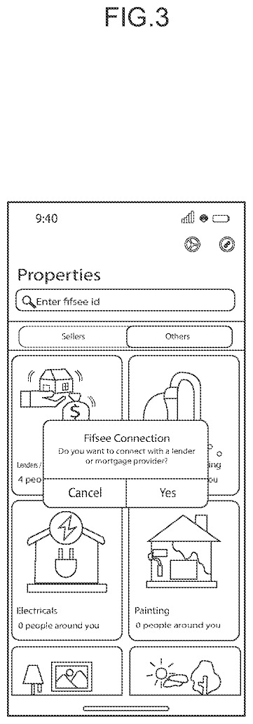

In FIG. 3 the invention discloses Fifsee connection feature of the present invention that help buyers and sellers to navigate themselves by answering questions to start finding Lenders, escrow officers, home inspectors etc. FIG. 3 is an example of the pop-up offering to find mortgage providers surrounding the profile owner.

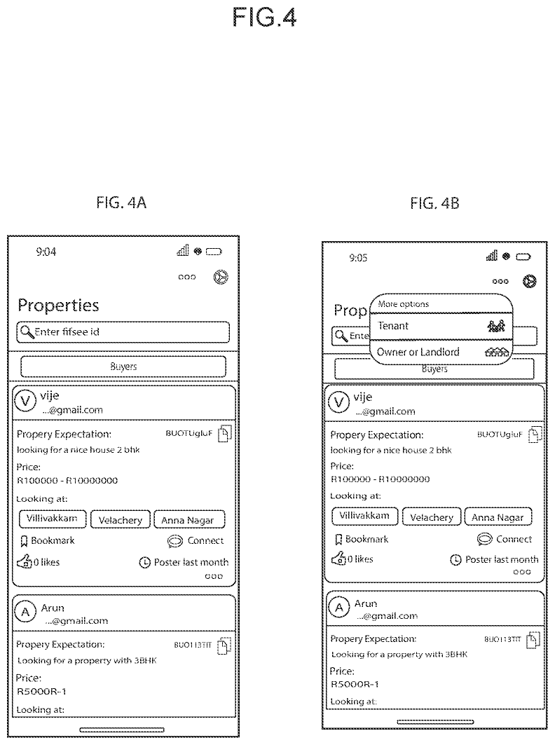

In FIG. 4a, the invention discloses the feed screen when a Lender logs in Fifsee, the lender gets to see all buyers in 100 miles range. The subscription fee starts with 100 miles range and provide more buyer options on feed per increased subscription fee of the application. Clicking the 3 dots on the top right will show tabs for Renters and Landlords, as shown in FIG. 4b.

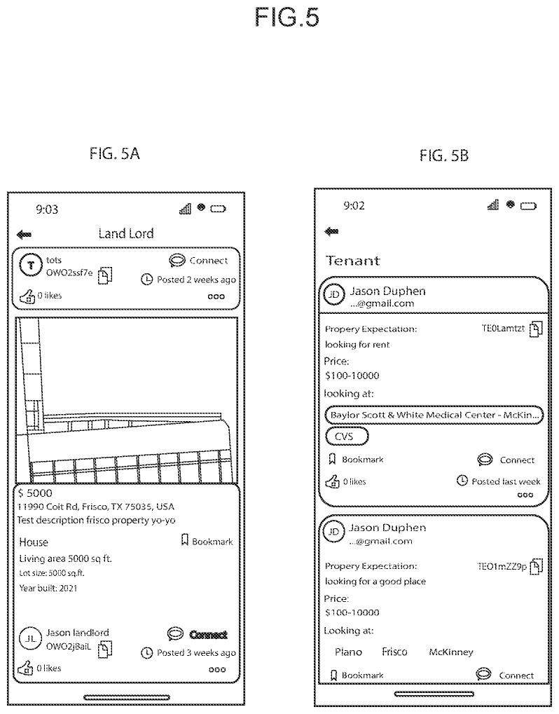

In FIG. 5a the invention discloses the feed screen for tenants and FIG. 5 discloses the feed screen for tenants.

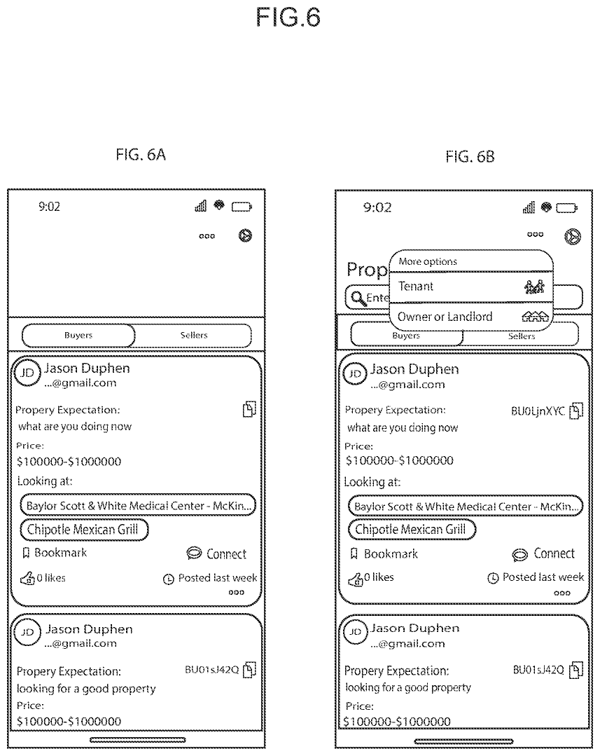

In FIG. 6, the invention discloses the feed screen for service providers such as; Photographers, Carper's cleaning, Electricals, Painting, Interior Design, Landscaping, Handyman, Movers and Local help, Other Home services, Retailers, Furniture Repair, Notary Services, Attorney Services, ESCROW officers, Appraisers, Home Inspector, HVAC services and Plumbers.

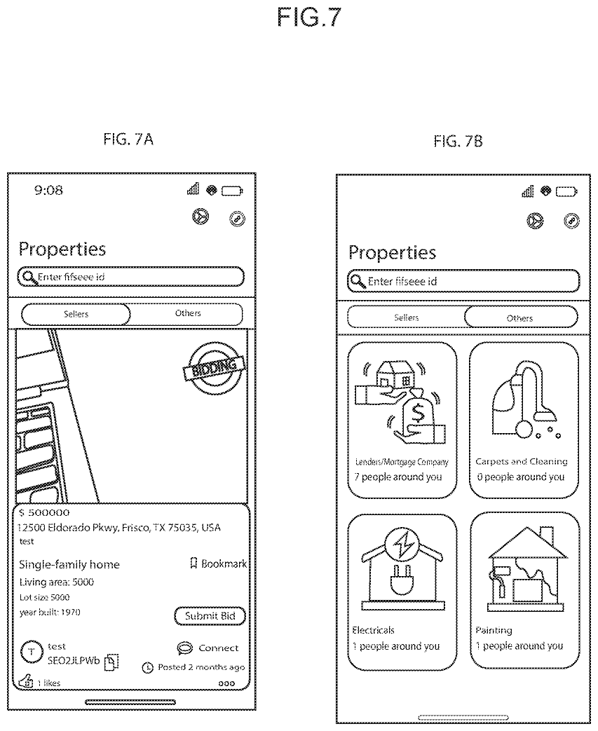

In FIG. 7a the invention discloses the feed screen for Buyers when Buyers login, they see sellers and information on seller and sellers' property. FIG. 7b further discloses the feed screen for others Photographers, Carper's cleaning, Electricals, Painting, Interior Design, Landscaping, Handyman, Movers and Local help, Other Home services, Retailers, Furniture Repair, Notary Services, Attorney Services, escrow officers, Appraisers, Home Inspector, HVAC services and Plumbers.

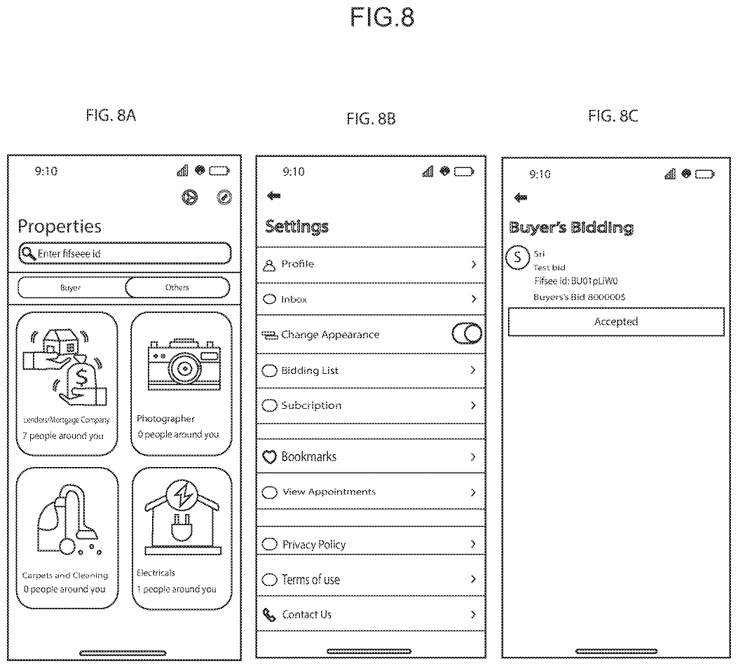

In FIG. 8a, the invention discloses feed screen for sellers. The sellers also get to see the tabs: “Buyer and Others”. When Buyers respond to Seller's bid, it appears in Bidding list page under sellers' settings as shown in FIG. 8b. The buyers will have the similar option as well, and buyers bidding is displayed in the screen as shown in FIG. 8c.

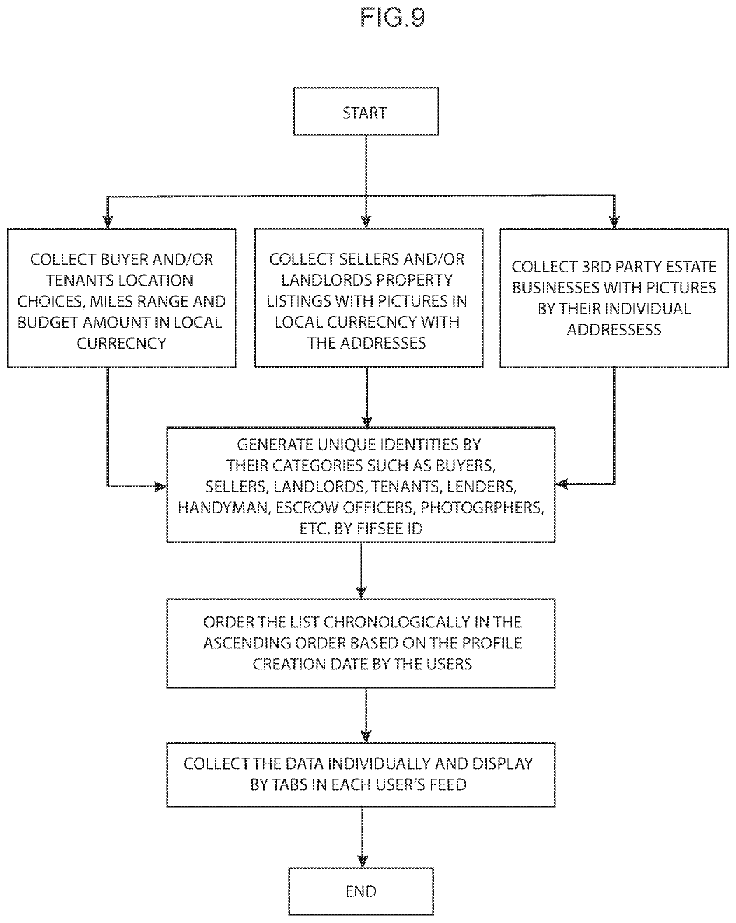

In FIG. 9, a flowchart representation of the present invention method and steps is displayed, further disclosing the start process, collection of user information, generating unique identities (FIFSEE ID) for users by their categories, Order the list chronologically in the ascending order based on the profile creation date by users, collect the data individually and display by tabs in each user's feed.

1. An online application and method for real estate transactions for buyers, sellers, renters and 3rd party real estate providers with at least one or more user profiles registered in the user interface of the application, the method comprising;
creating a database of information for all users, the database created from inputted information by users, including at least an Email id, Full name, password, address, price, and other parameters based on user options;
Spliting the users based on different profile category in the database and generating unique Fifsee ID per user. Example: Buyers Fifsee ID: BU12x34, Sellers Fifsee ID: SE12y34, Appraisers Fifsee ID: APP889w2, etc. and storing them in database;
providing data displayable for a particular user based on selected option;
enabling a user to respond to a request, chat, schedule meetings and appointment with other users for the physical inspection of a property, and other services based on provided information.

2. The method of claim 1, further displaying the user feed by split in tabs of all other users by their profile id; Locating Fifsee ID based on the address and price range from the sellers, buyers, tenants and landlords and populate the full set of parameters on each other's feed in the application user interface; Locating Fifsee ID of businesses (others) matching the location addresses and populate the full set of parameters on each other's feed by separating them on tabs in the application user interface such as Buyers tab, Sellers tab, landlords tab and tenants tab.
